(19) United States
(12) Patent Application Publication
(10) Pub. No.: US 2025/0316938 A1
(43) Pub. Date: Oct. 9, 2025

(54) TELESCOPIC STRUCTURE OF POWER ADAPTER PLUG

(71) Applicant: Huizhou Ouli Technology Co., Ltd., Huizhou (CN)

(72) Inventor: Song Liu, Huizhou (CN)

(21) Appl. No.: 19/098,955

(22) Filed: Apr. 2, 2025

(30) Foreign Application Priority Data
Apr. 8, 2024 (CN) 202410412989.0

(51) Int. Cl. H01R 31/06; H01R 13/04; H01R 13/426; H01R 13/512

(52) U.S. Cl. CPC H01R 31/06; H01R 13/04; H01R 13/426; H01R 13/512

(57) ABSTRACT

A telescopic structure of a power adapter plug is disclosed, which includes a housing, a push tab, a plug sleeve and a plug pin assembly, the plug sleeve being slidably mounted to the housing in a Z-axis direction, and the push tab being mounted to the plug sleeve; and further includes a fixing rod, a first rocker and a second rocker hingedly connected successively, where one end of the fixing rod away from the first rocker is fixed to the housing, and one end of the second rocker away from the first rocker is hingedly connected to the plug pin assembly, and the plug sleeve is provided with a driving chute; one end of the first rocker away from the fixing rod is provided with a driving protrusion, and the driving protrusion can be slidably mounted on the driving chute.

### CROSS-REFERENCE TO RELATED APPLICATIONS

This application claims priority to Chinese Patent Application No. 202410412989.0, filed on Apr. 8, 2024, the content of which is incorporated herein by reference in its entirety.

### TECHNICAL FIELD

The present application relates to the technical field of power adapters, and more particularly, to a telescopic structure of a power adapter plug.

### BACKGROUND

With an increase of global tourism and trade, a travel adaption plug or a travel adapter has been widely used. With the continuous improvement of technology, the types and functions of the adaption plug are also continuously updated and replaced.

However, due to the limitation of internal structure design, the existing plug has the following disadvantages: when plug pins are pushed out for use, it is necessary to firstly push the push tab to move a stage of stroke, so as to push a plug sleeve out of the housing; then, the push tab is pushed for the next stage of stroke to push the pins out of the housing and out of a lower end of the plug sleeve for use. Therefore, for the structure, it is necessary to reserve a large position and space on the plug, so that the push tab can complete two stages of stroke. Therefore, it takes up a large space and has a large volume, which is not conducive to the miniaturization of the product.

### SUMMARY

A technical problem to be solved by the present application is to provide a telescopic structure of a power adapter plug, which is of a compact structure.

In order to solve the above-mentioned technical problem, the technical solution adopted in the present application is: a telescopic structure of a power adapter plug, including a housing, a push tab, a plug sleeve and a plug pin assembly, the plug sleeve being slidably mounted to the housing in a Z-axis direction, the push tab being mounted to the plug sleeve, and the plug pin assembly being slidably mounted to the plug sleeve in the Z-axis direction, further including a fixing rod, a first rocker and a second rocker hingedly connected successively, where one end of the fixing rod away from the first rocker is fixed to the housing, and one end of the second rocker away from the first rocker is hingedly connected to the plug pin assembly, and the plug sleeve is provided with a driving chute; one end of the first rocker away from the fixing rod is provided with a driving protrusion, and the driving protrusion can be slidably mounted on the driving chute; when the plug sleeve slides out of the housing, the driving protrusion slides from a first end of the driving chute to a second end of the driving chute, an included angle between the first rocker and the second rocker increases, and the second rocker pushes the plug pin assembly out of the plug sleeve.

The beneficial effects of the present application are: the telescopic structure of the power adapter plug provided in the present application has the feature of a compact structure, where by pushing the push tab to move so as to make the plug sleeve extend out of the housing, and at the same time, the driving chute on the plug sleeve cooperates with the driving protrusion on the first rocker, so that an included angle between the first rocker and the second rocker increases, thereby enabling the plug pin assembly to generate two stages of displacement while the plug sleeve moves, i.e., the push tab moves for one stage of stroke, and the plug pin assembly can obtain two stages of stroke; it can be seen that when the plug sleeve and plug pin assembly are also pushed out, the stroke of the push tab can be set to be shorter, the proportion of space when the push tab is movable is reduced, which is beneficial to reducing a volume of a product and facilitating miniaturization of the whole product.

### BRIEF DESCRIPTION OF THE DRAWINGS

FIG. 1 is an assembly view of a telescopic structure of a power adapter plug according to an embodiment of the present application;

FIG. 2 is a cross-sectional view of a telescopic structure of a power adapter plug according to an embodiment of the present application;

FIG. 3 is an exploded view of a telescopic structure of a power adapter plug according to an embodiment of the present application; and

FIG. 4 is an exploded view of another view of a telescopic structure of a power adapter plug according to an embodiment of the present application.

### DESCRIPTION OF REFERENCE NUMERALS

1. upper housing; 11. upper support; 12. buffer; 2. lower housing; 21. lower support; 22. first limiting portion; 221. first limiting groove; 222. second limiting groove; 23. guide slide; 3. push tab; 31. handle; 32. strut; 321. first limiting protrusion; 322. compression spring; 33. second limiting portion; 331. third limiting groove; 332. fourth limiting groove; 4. plug sleeve; 41. driving chute; 411. first end; 412. second end; 42. avoidance groove; 5. fixing rod; 6. first rocker; 61. driving protrusion; 611. bearing; 7. second rocker; 71. buffer portion; 8. plug pin assembly; 81. second limiting protrusion; 82. avoidance hole.

### DETAILED DESCRIPTION OF THE EMBODIMENTS

In order to explain the technical contents, the objects, and the effects of the present application in detail, the embodiments will be described below referring to the accompanying drawings.

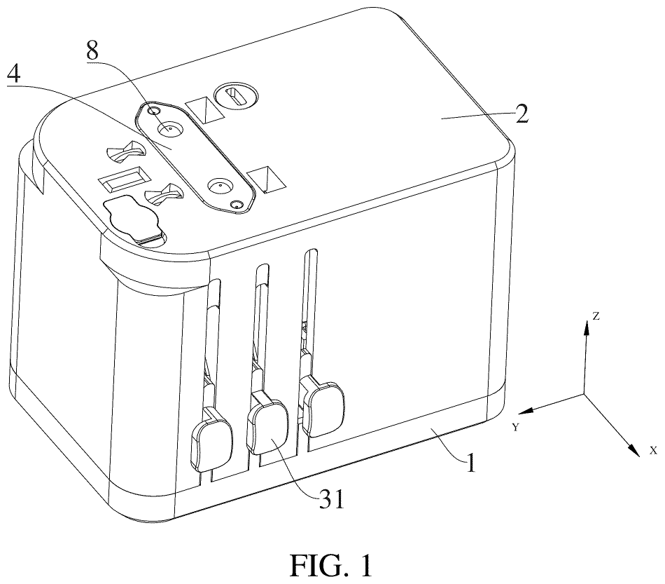

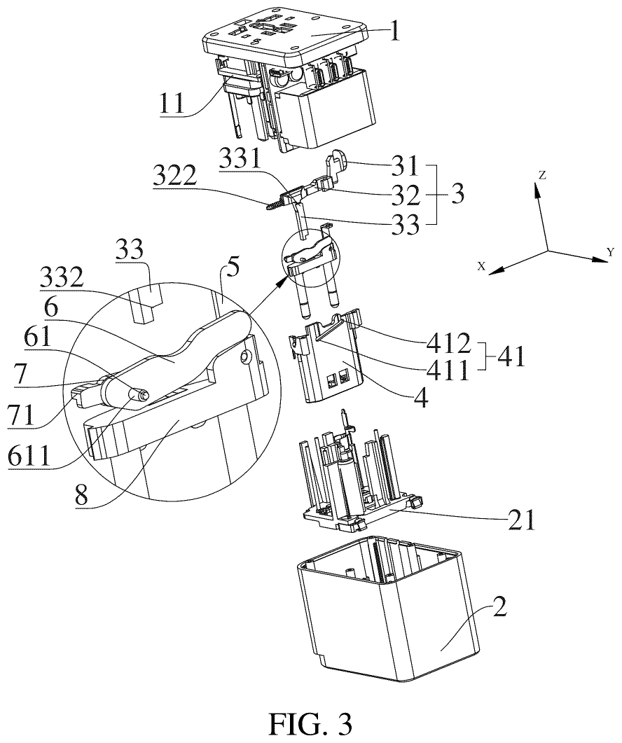

Referring to FIGS. 1 to 4, a telescopic structure of a power adapter plug includes a housing, a push tab 3, a plug sleeve 4 and a plug pin assembly 8, the plug sleeve 4 being slidably mounted to the housing in a Z-axis direction, the push tab 3 being mounted to the plug sleeve 4, and the plug pin assembly 8 being slidably mounted to the plug sleeve 4 in the Z-axis direction, and further includes a fixing rod 5, a first rocker 6 and a second rocker 7 hingedly connected successively, where one end of the fixing rod 5 away from the first rocker 6 is fixed to the housing, and one end of the second rocker 7 away from the first rocker 6 is hingedly connected to the plug pin assembly 8, and the plug sleeve 4 is provided with a driving chute 41, one end of the first rocker 6 away from the fixing rod 5 is provided with a driving protrusion 61, and the driving protrusion 61 can be slidably mounted on the driving chute 41; when the plug sleeve 4 slides out of the housing, the driving protrusion 61 slides from the first end 411 of the driving chute 41 to the second end 412 of the driving chute 41, an included angle between the first rocker 6 and the second rocker 7 increases, and the second rocker 7 pushes the plug pin assembly 8 out of the plug sleeve 4.

It can be seen from the above-mentioned description that the beneficial effects of the present application are: by pushing the push tab 3 to move so as to make the plug sleeve 4 extend out of the housing, and at the same time, the driving chute 41 on the plug sleeve 4 cooperates with the driving protrusion 61 on the first rocker 6, so that the included angle between the first rocker 6 and the second rocker 7 increases, thereby enabling the plug pin assembly 8 to generate two stages of displacement while the plug sleeve 4 moves, i.e., the push tab 3 moves for one stage of stroke, and the plug pin assembly 8 can obtain two stages of stroke; it can be seen that when the plug sleeve 4 and the plug pin assembly 8 are also pushed out, the stroke of the push tab 3 can be set to be shorter, the proportion of space when the push tab 3 is movable is reduced, which is beneficial to reducing a volume of a product and facilitating miniaturization of the whole product.

Further, the push tab 3 includes a handle 31 and a strut 32 connected, the handle 31 is located outside the housing, the strut 32 is slidably mounted on the plug sleeve 4 in an X-axis direction, a first limiting protrusion 321 is provided on the strut 32, a first limiting portion 22 extending in the Z-axis direction is provided in the housing, the first limiting portion 22 is provided with a first limiting groove 221 and a second limiting groove 222, and when the driving protrusion 61 is located at the first end 411 of the driving chute 41, the first limiting protrusion 321 abuts against and within the first limiting groove 221; and when the driving protrusion 61 is located at the second end 412 of the driving chute 41, the first limiting protrusion 321 abuts against and within the second limiting groove 222.

It can be seen from the above-mentioned description that the handle 31 is used for a user to operate the push tab 3, and the two limiting positions of the plug sleeve 4 when the housing moves can be locked by the cooperation of the first limiting protrusion 321 with the first limiting portion 22, i.e., when the first limiting protrusion 321 abuts against and within and within the first limiting groove 221, the plug sleeve 4 can be prevented from being loosened when fully retracted into the housing; when the first limiting protrusion 321 is in contact with the second limiting groove 222, the plug sleeve 4 can be prevented from being loosened when the plug sleeve 4 completely extends out of the housing; when it is necessary to extend and retract the plug sleeve 4, it is only necessary to press the handle 31 such that the first limiting protrusion 321 is disengaged from the first limiting portion 22.

Further, the push tab 3 is further provided with a second limiting portion 33 extending in the Z-axis direction, and the second limiting portion 33 is connected to the strut 32; the second limiting portion 33 is provided with a third limiting groove 331 and a fourth limiting groove 332, and the plug pin assembly 8 is provided with a second limiting protrusion 81; when the driving protrusion 61 is located at the first end 411 of the driving chute 41, the second limiting protrusion 81 abuts against and within the third limiting groove 331; when the driving protrusion 61 is located at the second end 412 of the driving chute 41, the second limiting protrusion 81 abuts against and within the fourth limiting groove 332.

It can be seen from the above-mentioned description that the two limiting positions of the plug pin assembly 8 when moving in the plug sleeve 4 can be locked by the cooperation of the second limiting protrusion 81 and the second limiting portion 33, i.e., when the second limiting protrusion 81 abuts against and within the third limiting groove 331, the plug pin can be prevented from being loosened when the plug pin is completely retracted into the plug sleeve 4; when the second limiting protrusion 81 is in contact with the fourth limiting groove 332, the plug pin assembly 8 can be prevented from being loosened when the plug pin assembly 8 completely extends out of the plug sleeve 4; the handle 31 is depressed to disengage the second limiting protrusion 81 from the second limiting portion 33 to unlock the plug pin assembly 8.

Further, the plug pin assembly 8 is provided with an avoidance hole 82 for avoiding the second limiting portion 33.

It can be seen from the above-mentioned description that the avoidance hole 82 can avoid the second limiting portion 33 from interfering with the plug pin assembly 8.

Further, the end of the strut 32 away from the handle 31 is sleeved with a compression spring, and the compression spring is connected to the plug sleeve 4.

It can be seen from the above-mentioned description that the compression spring can provide a reverse thrust force to the strut 32, ensuring that the first limiting protrusion 321 on the strut 32 can effectively abut against the first limiting portion 22, and ensuring that the second limiting portion 33 can effectively abut against the second limiting protrusion 81.

Further, an outer side wall of the plug sleeve 4 is further provided with an avoidance groove 42 extending in the Z-axis direction, and at least a portion of the first limiting portion 22 is located within the avoidance groove 42.

It can be seen from the above-mentioned description that the avoidance groove 42 can avoid the first limiting portion 22 to prevent from interfering with the plug sleeve 4.

Further, the driving protrusion 61 is sleeved with a bearing 611 for abutting against a side wall of the driving chute 41.

It can be seen from the above description that the provision of the bearing 611 on the driving protrusion 61 can reduce sliding friction between the driving protrusion 61 and the side wall of the driving chute 41, so that the movement of the driving protrusion 61 in the driving chute 41 is smoother.

Further, a buffer 12 is provided in the housing, a buffer portion 71 is provided at an end of the second rocker 7 away from the plug pin assembly 8, and the buffer portion 71 abuts against and within the buffer 12 when the driving protrusion 61 is located at the first end 411 of the driving chute 41.

It can be seen from the above description that the provision of the buffer 12 to abut against the buffer portion 71 of the second rocker 7 reduces the risk of damage to the second rocker 7.

Further, a guide slide 23 extending in the Z-axis direction is provided within the housing, and the plug sleeve 4 is slidably mounted to the guide slide 23.

It can be seen from the above-mentioned description that the guide slide 23 can guide the sliding of the plug sleeve 4 in the housing, ensuring the stability of the movement of the plug sleeve 4.

Further, the fixing rod 5 is mounted to the housing by a screw.

It can be seen from the above-mentioned description that the fixing rod 5 is fixed to the housing by means of a screw, so as to facilitate mounting; in particular, the mounting manner of the fixing rod 5 and the housing can be set according to actual application requirements.

Referring to FIGS. 1 to 4, an embodiment of the present application is: a telescopic structure of a power adapter plug includes a housing, a push tab 3, a plug sleeve 4 and a plug pin assembly 8, the plug sleeve 4 being slidably mounted to the housing in a Z-axis direction, the push tab 3 being mounted to the plug sleeve 4, and the plug pin assembly 8 being slidably mounted to the plug sleeve 4 in the Z-axis direction, and further includes a fixing rod 5, a first rocker 6 and a second rocker 7 hingedly connected successively, and specifically, the fixing rod 5, the first rocker 6 and the second rocker 7 are hingedly connected via the cooperation of a hinge shaft and a hinge hole; one end of the fixing rod 5 away from the first rocker 6 is fixed to the housing, and one end of the second rocker 7 away from the first rocker 6 is hingedly connected to the plug pin assembly 8, and the plug sleeve 4 is provided with a driving chute 41, one end of the first rocker 6 away from the fixing rod 5 is provided with a driving protrusion 61, and the driving protrusion 61 can be slidably mounted on the driving chute 41; when the plug sleeve 4 slides out of the housing, the driving protrusion 61 slides from the first end 411 of the driving chute 41 to the second end 412 of the driving chute 41, an included angle between the first rocker 6 and the second rocker 7 increases, and the second rocker 7 pushes the plug pin assembly 8 out of the plug sleeve 4; specifically, when the plug sleeve 4 is fully retracted into the housing and the plug pin assembly 8 is fully retracted into the plug sleeve 4, the driving protrusion 61 is located at the first end 411 of the driving chute 41, and at this time, the included angle between the first rocker 6 and the second rocker 7 is the smallest; when the plug sleeve 4 is fully exposed outside the housing and the plug pin assembly 8 is fully exposed outside the plug sleeve 4, the driving protrusion 61 is located at the second end 412 of the driving chute 41, and at this time, the included angle between the first rocker 6 and the second rocker 7 is the largest; as an alternative, the included angle between the first rocker 6 and the second rocker 7 varies in the range of from 0 to 180 deg. and the maximum value of the included angle between the first rocker 6 and the second rocker 7 can be set according to actual application requirements.

In detail, the housing includes an upper housing 1 and a lower housing 2 connected to the upper housing 1, where the lower housing 2 is provided with a plug hole for the plug sleeve 4 to extend through, the upper housing 1 is provided with an upper support 11, and the lower housing 2 is provided with a lower support 21; the fixing rod 5 is mounted on the upper support 11, and in some embodiments, the fixing rod 5 is fixed to the upper support 11 by a screw; the upper support 11 is further provided with a guide slide 23 extending in the Z-axis direction, one end of the guide slide 23 away from the upper support 11 is connected to the lower support 21, and the plug sleeve 4 is slidably mounted to the guide slide 23; the guide slide 23 can guide the sliding of the plug sleeve 4 in the housing, and ensure the stability of the movement of the plug sleeve 4.

In addition, in some embodiments, the fixing rod 5 may also be attached to the upper support 11 by gluing, such that the assembly process is simple and the assembly difficulty is reduced. Alternatively, the fixing rod 5 may be integrally formed with the upper support 11 through an over-mold process, such that the assembly process can be omitted, and the assembly accuracy can be improved to facilitate the improvement of the yield of the product.

Preferably, the push tab 3 includes a handle 31 and a strut 32 connected, the handle 31 is located outside the housing, the strut 32 is slidably mounted on the plug sleeve 4 in the X-axis direction, a first limiting protrusion 321 is provided on the strut 32, a first limiting portion 22 extending in the Z-axis direction is provided in the housing, the first limiting portion 22 is provided with a first limiting groove 221 and a second limiting groove 222, and when the driving protrusion 61 is located at a first end 411 of the driving chute 41, the first limiting protrusion 321 abuts against and within the inside of the first limiting groove 221; when the driving protrusion 61 is located at the second end 412 of the driving chute 41, the first limiting protrusion 321 abuts against and within the second limiting groove 222, the handle 31 is used for a user to operate the push tab 3, and the two limit positions of the plug sleeve 4 when the housing moves can be locked by the cooperation of the first limiting protrusion 321 with the first limiting portion 22, i.e., when the first limiting protrusion 321 abuts against and within the first limiting groove 221, the plug sleeve 4 can be prevented from being loosened when fully retracted into the housing; when the first limiting protrusion 321 is in contact with the second limiting groove 222, the plug sleeve 4 can be prevented from being loosened when the plug sleeve 4 completely extends out of the housing; when it is necessary to extend and retract the plug sleeve 4, it is only necessary to press the handle 31 such that the first limiting protrusion 321 is disengaged from the first limiting portion 22.

Specifically, the push tab 3 is further provided with a second limiting portion 33 extending in the Z-axis direction, the second limiting portion 33 being connected to the strut 32; the second limiting portion 33 is provided with a third limiting groove 331 and a fourth limiting groove 332, and the plug pin assembly 8 is provided with a second limiting protrusion 81; when the driving protrusion 61 is located at the first end 411 of the driving chute 41, the second limiting protrusion 81 abuts against and within the third limiting groove 331; when the driving protrusion 61 is located at the second end 412 of the driving chute 41, the second limiting protrusion 81 abuts against and within the fourth limiting groove 332; it can be understood that the two limiting positions of the plug pin assembly 8 when moving in the plug sleeve 4 can be locked by the cooperation of the second limiting protrusion 81 and the second limiting portion 33, i.e., when the second limiting protrusion 81 abuts against and within the third limiting groove 331, the plug pin can be prevented from being loosened when the plug pin is completely retracted into the plug sleeve 4; when the second limiting protrusion 81 is in contact with the fourth limiting groove 332, the plug pin assembly 8 can be prevented from being loosened when the plug pin assembly 8 completely extends out of the plug sleeve 4; the handle 31 is depressed to disengage the second limiting protrusion 81 from the second limiting portion 33 to unlock the plug pin assembly 8; in detail, a compression spring 322 is sleeved at an end of the strut 32 away from the handle 31, the compression spring 322 is connected to the plug sleeve 4, and the compression spring 322 can provide a reverse thrust force to the strut 32, ensuring that the first limiting protrusion 321 on the strut 32 can effectively abut against the first limiting portion 22, and ensuring that the second limiting portion 33 can effectively abut against the second limiting protrusion 81.

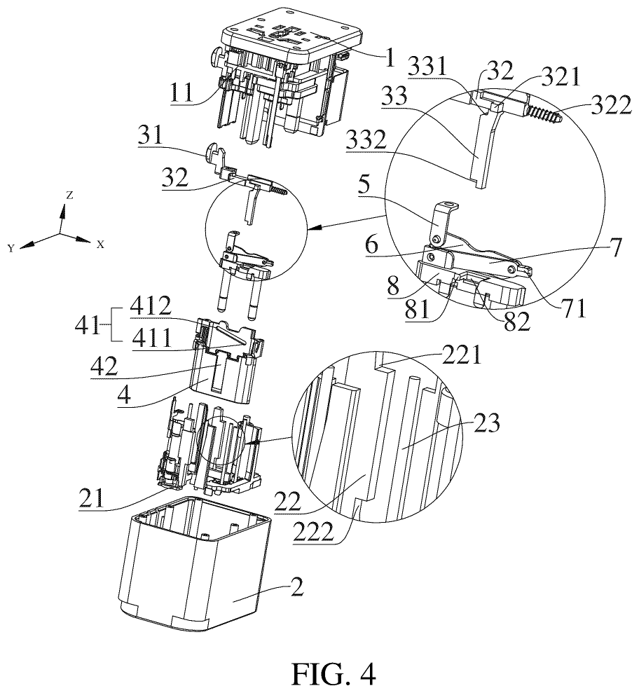

Referring to FIG. 4, the plug pin assembly 8 is provided with an avoidance hole 82 for avoiding the second limiting portion 33 and the avoidance hole 82 can avoid the second limiting portion 33 from interfering with the plug pin assembly 8; specifically, an outer side wall of the plug sleeve 4 is further provided with an avoidance groove 42 extending in the Z-axis direction, and at least a portion of the first limiting portion 22 is located within the avoidance groove 42, and the avoidance groove 42 can prevent the first limiting portion 22 from interfering with the plug sleeve 4 and the avoidance groove 42 can avoid the first limiting portion 22 to prevent from interfering with the plug sleeve 4.

Alternatively, in some embodiments, the driving protrusion 61 is sleeved with a bearing 611 for abutting against a side wall of the driving chute 41, the provision of the bearing 611 on the driving protrusion 61 can reduce sliding friction between the driving protrusion 61 and the side wall of the driving chute 41, so that the movement of the driving protrusion 61 in the driving chute 41 is smoother.

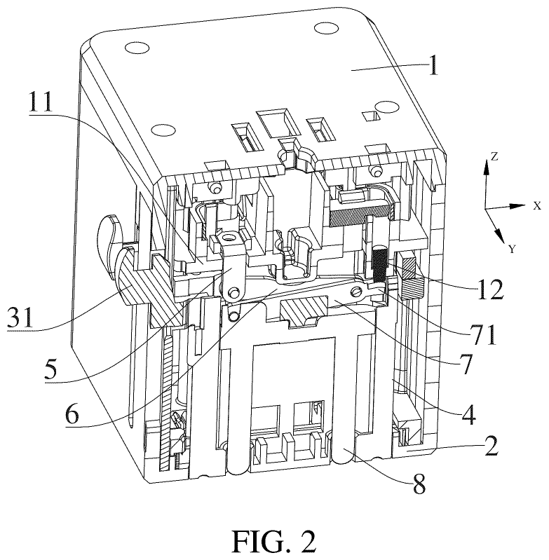

Preferably, in conjunction with FIG. 2, a buffer 12 is provided in the housing and mounted on the upper support 11, one end of the second rocker 7 away from the plug pin assembly 8 is provided with a buffer portion 71, and when the driving protrusion 61 is located at a first end 411 of the driving chute 41, the buffer portion 71 abuts against and within the buffer 12, and the buffer 12 is provided to abut against the buffer portion 71 on the second rocker 7, such that the risk of damage to the second rocker 7 can be reduced; specifically, the buffer 12 may be a rubber soft pad or a glass bead screw, which can be specifically selected according to actual application requirements, and will not be described in detail herein.

In summary, the telescopic structure of the power adapter plug provided in the present application has the feature of a compact structure, where by pushing the push tab to move so as to make the plug sleeve extend out of the housing, and at the same time, the driving chute on the plug sleeve cooperates with the driving protrusion on the first rocker, so that an included angle between the first rocker and the second rocker increases, thereby enabling the plug pin assembly to generate two stages of displacement while the plug sleeve moves, i.e., the push tab moves for one stage of stroke, and the plug pin assembly can obtain two stages of stroke; it can be seen that when the plug sleeve and plug pin assembly are also pushed out, the stroke of the push tab can be set to be shorter, the proportion of space when the push tab is movable is reduced, which is beneficial to reducing a volume of a product and facilitating miniaturization of the whole product.

The above description is merely illustrative of the embodiments of the present application and does not limit the patent protection scope of the present application, any equivalent transformations made with the description and drawings of the present application, or direct or indirect applications in related technical fields, shall similarly fall within the patent protection scope of the present application.

1. A telescopic structure of a power adapter plug, comprising a housing, a push tab, a plug sleeve and a plug pin assembly, the plug sleeve being slidably mounted to the housing in a Z-axis direction, the push tab being mounted to the plug sleeve, and the plug pin assembly being slidably mounted to the plug sleeve in the Z-axis direction, further comprising a fixing rod, a first rocker and a second rocker hingedly connected successively, wherein one end of the fixing rod away from the first rocker is fixed to the housing, and one end of the second rocker away from the first rocker is hingedly connected to the plug pin assembly, and the plug sleeve is provided with a driving chute; one end of the first rocker away from the fixing rod is provided with a driving protrusion, and the driving protrusion can be slidably mounted on the driving chute; when the plug sleeve slides out of the housing, the driving protrusion slides from a first end of the driving chute to a second end of the driving chute, an included angle between the first rocker and the second rocker increases, and the second rocker pushes the plug pin assembly out of the plug sleeve.

2. The telescopic structure of a power adapter plug according to claim 1, wherein the push tab comprises a handle and a strut connected, the handle is located outside the housing, the strut is slidably mounted on the plug sleeve in an X-axis direction, a first limiting protrusion is provided on the strut, a first limiting portion extending in the Z-axis direction is provided in the housing, the first limiting portion is provided with a first limiting groove and a second limiting groove, and when the driving protrusion is located at the first end of the driving chute, the first limiting protrusion abuts against and within the first limiting groove; and when the driving protrusion is located at the second end of the driving chute, the first limiting protrusion abuts against and within the second limiting groove.

3. The telescopic structure of a power adapter plug according to claim 2, wherein the push tab is further provided with a second limiting portion extending in the Z-axis direction, and the second limiting portion is connected to the strut; the second limiting portion is provided with a third limiting groove and a fourth limiting groove, and the plug pin assembly is provided with a second limiting protrusion; when the driving protrusion is located at the first end of the driving chute, the second limiting protrusion abuts against and within the third limiting groove; and when the driving protrusion is located at the second end of the driving chute, the second limiting protrusion abuts against and within the fourth limiting groove.

4. The telescopic structure of a power adapter plug according to claim 3, wherein the plug pin assembly is provided with an avoidance hole for avoiding the second limiting portion.

5. The telescopic structure of a power adapter plug according to claim 2, wherein one end of the strut away from the handle is sleeved with a compression spring, and the compression spring is connected to the plug sleeve.

6. The telescopic structure of a power adapter plug according to claim 3, wherein one end of the strut away from the handle is sleeved with a compression spring, and the compression spring is connected to the plug sleeve.

7. The telescopic structure of a power adapter plug according to claim 2, wherein an outer side wall of the plug sleeve is further provided with an avoidance groove extending in the Z-axis direction, and at least a part of the first limiting portion is located in the avoidance groove.

8. The telescopic structure of a power adapter plug according to claim 1, wherein the driving protrusion is sleeved with a bearing for abutting against a side wall of the driving chute.

9. The telescopic structure of a power adapter plug according to claim 1, wherein a buffer is provided in the housing, a buffer portion is provided at an end of the second rocker away from the plug pin assembly, and the buffer portion abuts against the buffer when the driving protrusion is located at the first end of the driving chute.

10. The telescopic structure of a power adapter plug according to claim 1, wherein a guide slide extending in the Z-axis direction is provided in the housing, and the plug sleeve is slidably mounted to the guide slide.

11. The telescopic structure of a power adapter plug according to claim 1, wherein the fixing rod is mounted to the housing by a screw.
